(19) United States
(12) Patent Application Publication
(10) Pub. No.: US 2010/0163221 A1
(43) Pub. Date: Jul. 1, 2010

(54) LOCAL CONTROL OF HEAT FLOW TO MORE ACCURATELY REGULATE MACHINE TEMPERATURES

(75) Inventors: Theo Anjes Maria Ruijl, Oirschot (NL); Hendrik Jan Eggink, Oirschot (NL); Jacobus Cornelis Gerardus Van Der Sanden, Geldrop (NL); Ralph Theodorus Hubertus Maessen, Roermond (NL); Jeroen Dekkers, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/095,635

(22) PCT Filed: Nov. 14, 2006
(86) PCT No.: PCT/IB2006/054257

§ 371 Date: May 30, 2008

Related U.S. Application Data
(60) Provisional application No. 60/740,864, filed on Nov. 30, 2005.

(51) Int. Cl. G05D 23/19; F25D 17/00

(52) U.S. Cl. 165/247; 165/260; 165/294; 165/299; 62/177

(57) ABSTRACT

A temperature regulation method and system (100) includes a reservoir (112) having a fluid with a temperature of a value such that, within a control range of a local temperature controller, a local set point temperature is achievable. A piping system (101) delivers the fluid from the reservoir to one or more elements needing temperature control. A heat generator/removal device (110) in one of the fluid paths is disposed at or near an element needing temperature control. For each heat generator/removal device, a local temperature controller (116) and a feedback sensor (114) are configured to control the heat generator/removal device such that an amount of heat exchanged with the fluid, at or near the element needing temperature control, results in a local temperature, monitored by the control feedback sensor to be locally and accurately maintained at the local set point temperature.

This disclosure relates to temperature control systems and more particularly to a system and method that provides local temperature control to permit independent and accurate temperature regulation in different areas of a system.

In many systems, cooling water is needed to remove heat from heat generation sources. Heat generation sources may include motors, actuators, molds, processes or other energy sources. Heat regulation is needed to condition machine parts, products and or process temperatures to provide proper operation of devices and ensure predictable behavior of processes. In such systems, cooling fluid is normally supplied from a temperature controlled reservoir. However, fast temperature control is nearly impossible since the cooling water volume in the reservoir takes time to adjust. In addition, the temperature is limited to a single temperature set point.

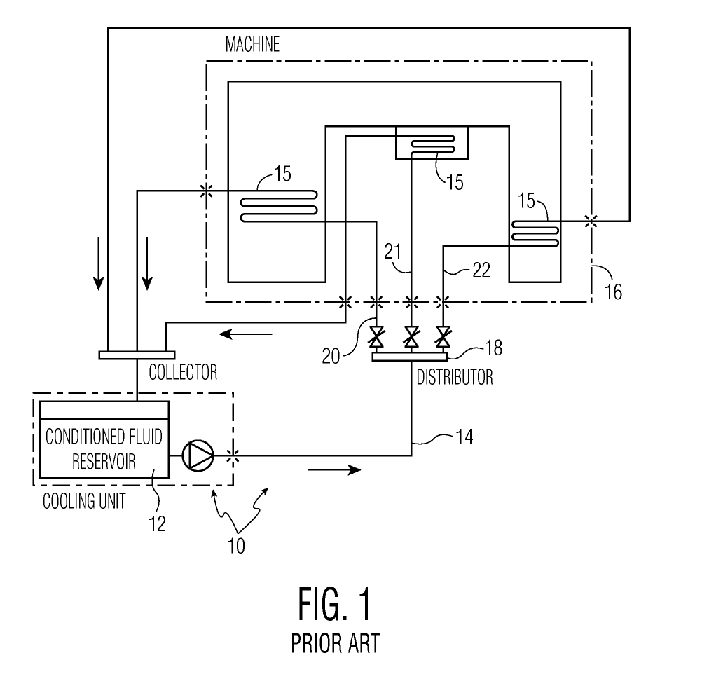

Referring to FIG. 1, a machine cooling apparatus 10 is shown. Cooling water is normally supplied from a water reservoir 12 that is temperature controlled to a network of pipes 14. The piping 14 may include multiple passes (heat exchangers 15) to remove heat from multiple heat sources at different locations in the system and or to condition parts that require a curtain absolute temperature level. The temperature set point of the water in the reservoir 12 is normally set to a fixed value or controlled in a very slow feed back loop with a temperature sensor to compensate for drift effects. In high precision machines or equipment 16 that requires accurate and stable machine temperatures, this method of cooling has some important drawbacks, namely the capacity of the reservoir makes it impossible to respond or quickly anticipate temperature or heat load changes in a machine, which results in temperature fluctuations. Furthermore, the cooling water of a single reservoir 12 is often supplied in parallel to multiple heat exchangers in the machine, which will result locally in different average machine temperatures depending on the amount of coolant flow to a local exchanger and the local heat sources. For example, reservoir 12 feeds a manifold 18 that supplies three piping paths 20, 21 and 22. Each path passes to a different part of machine, and consequently a different heat load, but all paths return to the cooling unit reservoir 12.

With large and small heat sources in a machine, the large heat sources will require large coolant flows to realize a more or less uniform machine temperature. Large coolant flows introduce vibrations by requiring more pumping power. These vibrations are one of the main sources of mechanical vibrations in high precision machines.

In accordance with illustrative embodiments, by using locally controlled heat generators and heat sinks, the amount of heat removed or added by a fluid, results in better and faster controlled local machine temperatures.

A temperature regulation system includes a heat generator/removal device coupled to a piping system at a location at or near an element having a need for temperature control. The piping system is configured to deliver a fluid with a temperature of a value, such that within a control range of a local temperature control, a local set point temperature can be reached, to one or more elements needing temperature control. A controller with a feedback sensor is configured to control a heat generator/removal device such that the amount of heat exchanged with the fluid to, at or near the element needing temperature control, results in a local temperature, monitored by the control feedback sensor, accurately maintained at the controller set point temperature.

A temperature regulation method and system includes a reservoir having a fluid with a temperature of a value such that, within a control range of a local temperature controller, a local set point temperature is achievable. A piping system delivers the fluid from the reservoir in parallel to one or more elements needing temperature control. A heat generator/removal device in one of the fluid paths is disposed at or near an element needing temperature control. For each heat generator/removal device, a local temperature controller and a feedback sensor are configured to control the heat generator/removal device such that an amount of heat exchanged with the fluid, at or near the element needing temperature control, results in a local temperature, monitored by the control feedback sensor to be locally and accurately maintained at the local set point temperature.

These and other objects, features and advantages of the present disclosure will become apparent from the following detailed description of illustrative embodiments thereof, which is to be read in connection with the accompanying drawings.

This disclosure will present in detail the following description of preferred embodiments with reference to the following figures wherein:

FIG. 1 is a schematic diagram showing a prior art machine cooling apparatus;

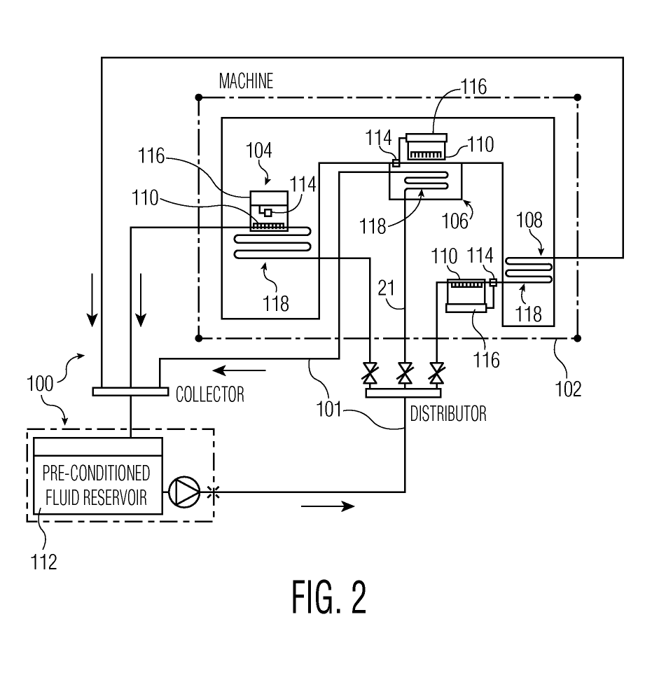

FIG. 2 is a schematic diagram showing a machine cooling apparatus having local temperature control devices distributed through the machine to provide local heat flow control in accordance with one illustrative embodiment;

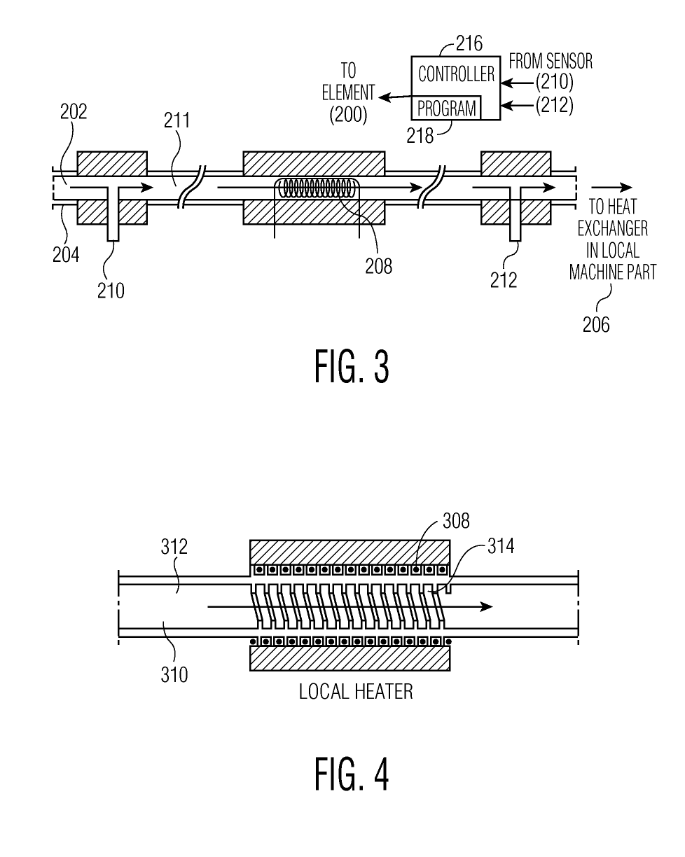

FIG. 3 is a cross-sectional view showing an illustrative heat flow control device having feed forward and feed back sensors to monitor and control incoming and outgoing fluid temperatures;

FIG. 4 is a cross-sectional view showing an illustrative heat flow control device having a local heater disposed outside of the flow area;

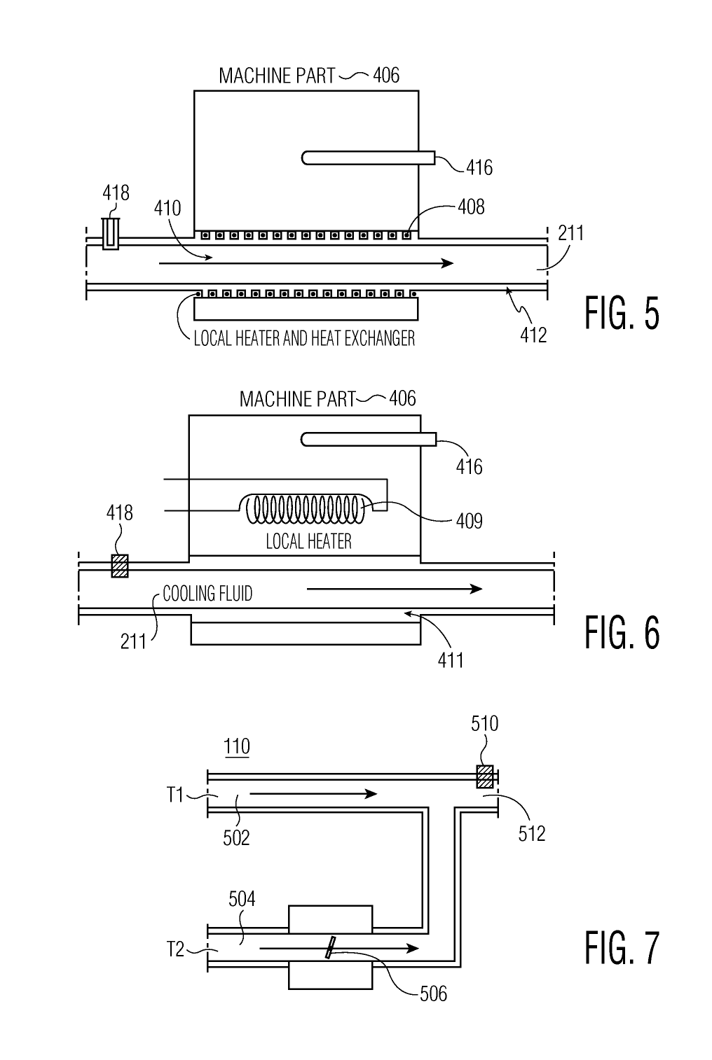

FIG. 5 is a cross-sectional view showing an illustrative heat flow control device having a feed back sensor mounted on or in a machine part to be temperature controlled;

FIG. 6 is a cross-sectional view showing an illustrative heat flow control device where the device includes a feed back sensor and a heater mounted on or in a machine part to be temperature controlled; and

FIG. 7 is a cross-sectional view showing an illustrative heat flow control device having a different temperature flows mixed to achieve a desired output temperature flow where at least one of the flows is gated by a valve to control the outgoing fluid temperature.

The present disclosure illustratively provides a system, apparatus and method which are employed to promote rapid and accurate temperature control of systems using a single reservoir. While the present invention may employ multiple reservoirs, illustrative embodiment as described herein, may share a single reservoir since the temperature of each point of interest may be controlled locally.

It should be understood that the elements shown in the FIGS. may be implemented in various forms of hardware. While embodiments will be described in terms of a cooling fluid and local heaters, the reverse scenario where warm fluid and cooling devices may also be employed. Cooling devices may include, e.g., mixing a cold fluid stream in a hot main stream or using a refrigerant type heat exchanger locally. In addition, heating and cooling may be performed locally at a single location depending on the conditions.

Heating and cooling elements may be realized in many ways. For example, heating coils may include heated fluid passing through a tube, electrically resistive coils, radiation, or any other heating method. For illustrative purposes, the heating elements described herein include resistive heating coils; however, as mentioned the present invention is not limited to this type of heating elements. The elements depicted in the FIGS. may be implemented in various combinations and provide functions which may be combined in a single element or multiple elements. For example, a single machine may have a single temperature control device or a plurality of temperature control devices employing one or more controlled temperature reservoirs.

Referring now to the drawings in which like numerals represent the same or similar elements and initially to FIG. 2, a system 100 for locally monitoring and controlling temperature is illustratively shown. System 100 is shown in an illustrative configuration for a machine 102 having three locations 104, 106 and 108 where temperature is locally controlled using a piping system 101. Other configurations and machines where embodiments of the present invention may be applied include polymer molding, bearings, devices with electromechanical elements, motors, actuators, resistive heating due to electrical currents, lasers/diode or semiconductor elements, geometric measuring machines, IC manufacturing equipment or any other application where temperature control is needed in one or more locations.

Local thermal elements 110 are employed to locally control the amount of heat added/removed by a circulated reservoir fluid 211 (FIG. 2), such as, e.g., water. Preferably, fluid 211 includes a single phase liquid, although a single phase gas may be employed as well. Advantageously, local temperatures for machine devices or areas of interest can be better and more rapidly controlled using local thermal elements 110. In one embodiment, to make positive heat and negative heat (heat removal) control with the heaters possible, the input fluid temperature is set to a point that is below a desired machine temperature so that in the nominal situation the heater is always generating heat. For example, in a specific case, a precision machine may need local temperature conditioning of 22.00±0.01 degrees C., the temperature of the cooling fluid (e.g., water) in a cooling reservoir 112 may be set to about 21.5 degrees C. More generally, the input fluid temperature is set to a value such that within a control range of local temperature control the local set point temperature can be achieved or reached. Being able to use cooling water with a lower temperature makes it is possible to cool large heat sources with much smaller water flows, which in turn reduces vibration levels. The coolant flow is employed as a negative heat source to draw heat away from locations 104, 106 and 108 of the machine 102 to compensate for positive heat sources in the machine or heat generated by local thermal elements 110 (e.g., heaters in this case).

With the machine temperature at locations 104, 106 and 108 controlled by the local heaters 110 a high temperature requirement on the fluid in the reservoir 112 is not necessary. Controlling the water or machine temperatures locally close to the heat sources makes it possible to react and anticipate changes in the heat sources much faster. Local thermal elements 110 are controlled by a controller 116 based on a temperature signal monitored by a feedback sensor 114 at or near locations 104, 106 and 108. At or near means in the vicinity and may be upstream to the actual part or area to be monitored location, but still local to that area. With the feed back sensor 114 close to or at the point of interest, local machine temperatures can be much more accurately controlled. Each local thermal element 110 uses a controller 116 and a feedback sensor 114 to make independent temperature control of the local areas possible. A feed forward (sensor) signal may also be applied to anticipate known heat sources or related temperature changes to optimize the temperature control accuracy. Advantageously, a single reservoir may be employed to regulate temperatures of a plurality of points of interest. In addition, each point of interest may be programmed or set to a specific temperature or temperature profile which is independent from the other locally controlled areas. Further, since the temperature is locally controlled, it may be independent of the reservoir fluid temperature.

In the example, one or more local thermal elements (heaters) 110 are used to control machine temperature locally by regulating the amount of heat that is removed by the cooling fluid. The cooling fluid with a temperature below the desired machine temperature is supplied from the reservoir 112 in parallel (although serial arrangements are also contemplated) to different locations where the local thermal elements 110 are placed. Each local thermal element 110 will add the proper amount of heat to the cooling fluid locally to control the machine temperature. Using the precision machine example, the desired local temperature may be, e.g., 22 degrees C., a local feedback sensor 114 would sense the local temperature (initially 21.5 degrees C.) on which the controller 116 will react (because of an offset relative to the control set point of 22 degrees C.) by steering or driving the heater 110 (for example using PI-control) to supply heat to try to reach and maintain the desired set point temperature. The heaters 110 can be used to heat the coolant stream, going to a local heat exchanger 118, to the appropriate temperature level. The heater can also be integrated with the machine part that is to be temperature controlled.

Referring to FIG. 3, an embodiment is illustratively shown where a cooling fluid 202 in a supply line 204 to a heat exchanger 206 is heated by an electrical heater 208 in the fluid stream. The principals of operation are illustratively described in terms of a heating element 208; however, a cooling element may be employed in addition to or instead of heater 208. A signal from a temperature sensor 210 in front of the heater 208 can be used as a feed forward control to compensate for temperature fluctuations in the incoming fluid from a reservoir (e.g., reservoir 112 in FIG. 2). The feed forward control 210 can also be applied to anticipate for known heat source fluctuations (for example, an increasing motor current, a rotational speed increase for a shaft in a bearing, anticipated cycle temperature changes in a mold, etc.). A temperature sensor 212 is provided and after the heater 208 is used to control the temperature level of the fluid 202 going to the local heat exchanger 206. This feed back sensor 212 can also be positioned at the machine part or device that needs to be temperature controlled.

A controller 216 is employed to collect signals from sensors 210 and 212 and to steer the heater (or cooler) 208 (using for example a PI or PID-control algorithm) to try to keep the temperature monitored by the feedback sensor 212 as close as possible to the temperature set point or set point profile. In one embodiment, a temperature profile program 218 may be synchronized with a triggering event, e.g., higher current draw, a point in a molding cycle, speed change in a bearing, etc. In this way, the controller can better anticipate known heat load changes resulting in smaller control errors.

Referring to FIG. 4, an embodiment is shown in which an electrical heater 308 is placed in a spiral around a cooling supply channel 310. In this way, the heater 308 is kept outside a cooling fluid 312. At the inside of the channel 310, a spiral shaped fin 314 is present to enhance heat transfer to the fluid 312.

Referring to FIGS. 5 and 6, embodiments in which heaters 408, 409 are integrated with machine parts 406 to be temperature controlled are illustratively shown. FIG. 5 shows an embodiment in which the heater 408 is integrated with a fluid heat exchanger 410. A heater wire in this embodiment is placed in a spiral around a fluid channel 412 and a feedback temperature sensor 416 is included in the machine part 406. In FIG. 6, the heater 409 is separated from a fluid heat exchanger 411. In these cases, the temperature control is fed back with the temperature measured by the temperature sensor 416 on the machine part 406 to be conditioned. A feed forward control 418 may also be applied to the temperature of the incoming fluid or on, e.g., actuator currents or other parameters that can be measured, which could affect the temperature locally.

Referring to FIG. 7, an embodiment of a heat generating/removal device is shown in which a fluid temperature is adjusted by merging two or more fluid streams 502 and 504 with different temperatures T1 and T2. The fluid temperature is controlled by adjusting a flow of one of the two fluid streams 502 or 504 using a valve 506. The valve 506 may be controlled using a feedback sensor 510 which is employed to measure a temperature of a mixed fluid flow 512. Mixed fluid flow 512 may be employed as a cooling or heating mechanism for locally controlling a temperature. An advantage of this embodiment is that the coolant temperature can be adjusted almost instantaneously. This method includes two coolant supplies to provide each of flows 502 and 548. In other embodiment, a greater number of flows may be employed.

Embodiments described herein can be applied in all machines, systems or products where temperature control/conditioning by fluid is needed. The embodiments for temperature control are especially useful in high precision machine and equipment which needs high thermal accuracy and stability.

Having described preferred embodiments for systems, apparatuses and methods for local control of heat flow to more accurately regulate machine temperatures (which are intended to be illustrative and not limiting), it is noted that modifications and variations can be made by persons skilled in the art in light of the above teachings. It is therefore to be understood that changes may be made in the particular embodiments of the disclosure disclosed which are within the scope and spirit of the embodiments disclosed herein as outlined by the appended claims. Having thus described the details and particularity required by the patent laws, what is claimed and desired protected by Letters Patent is set forth in the appended claims.

In interpreting the appended claims, it should be understood that:
a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function;
e) any of the disclosed elements may be comprised of hardware portions (e.g., including discrete and integrated electronic circuitry), software portions (e.g., computer programming), and any combination thereof;
f) hardware portions may be comprised of one or both of analog and digital portions;
g) any of the disclosed devices or portions thereof may be combined together or separated into further portions unless specifically stated otherwise; and
h) no specific sequence of acts is intended to be required unless specifically indicated.

1. A temperature regulation system (100), comprising
a reservoir (112) having a fluid with a temperature of a value such that, within a control range of a local temperature controller (116), a local set point temperature is achievable;
a piping system (101) to deliver the fluid from the reservoir to one or more elements needing temperature control;
at least one heat generator/removal device (110) in one of the fluid paths disposed at or near an element needing temperature control (118); and
for each heat generator/removal device, a local temperature controller (116) and a feedback sensor (114) configured to control the heat generator/removal device such that an amount of heat exchanged with the fluid, at or near the element needing temperature control, results in a local temperature, monitored by the control feedback sensor to be locally and accurately maintained at the local set point temperature.

2. The system as recited in claim 1, further comprising a feed forward signal (210) used by the local temperature controller to anticipate heat loads or related temperature changes.

3. The system as recited in claim 1, further comprising a feed forward sensor (210) configured to monitor a temperature of incoming fluid used by the local temperature controller to anticipate incoming fluid temperature fluctuations.

4. The system as recited in claim 1, wherein the piping system (101) delivers the fluid from the reservoir in parallel to the one or more elements needing temperature control.

5. The system as recited in claim 1, wherein the feedback sensor (114) is located within a machine element needing to be temperature monitored.

6. The system as recited in claim 1, wherein the feedback sensor (114) is located within the piping system at or near a machine element needing to be temperature monitored

7. The system as recited in claim 1, wherein the feed back sensor (114) monitors a temperature of an outgoing fluid such that the outgoing fluid temperature is controlled with the heat generator/removal device.

8. The system as recited in claim 1, further comprising the local temperature controller (110) configured to activate the heat generator/removal device in accordance with a triggering event.

9. The system as recited in claim 8, wherein the triggering event includes a change in operation of a machine element needing to be temperature monitored.

10. The system as recited in claim 1, wherein the heat generator/removal device (110) includes a mixture of fluids (512) from a plurality of flows of different temperatures wherein at least one of the flows is regulated to provide a desired temperature.

11. A temperature regulation system (100), comprising
a reservoir (112) having a fluid with a controlled temperature of a first value;
a piping system (101) configured to deliver the fluid from the reservoir to one or more elements needing temperature control;
a heat generating device (110) disposed at a location at or near an element needing temperature control, the heat generating device being configured to apply heat to control the element needing temperature control; and
a local controller (116) configured to activate the heat generating device in accordance with a feedback sensor (114) such that the heat generator device applies heat to increase the temperature above the first value to locally and accurately maintain a set point temperature at the element needing temperature control.

12. The system as recited in claim 11, further comprising a feed forward signal (210) used by the local controller to anticipate known heat loads or related temperature changes.

13. The system as recited in claim 11, further comprising a feed forward sensor (210) configured to monitor a temperature of incoming fluid used by the local controller to anticipate incoming fluid temperature fluctuations.

14. The system as recited in claim 11, wherein the piping system (101) delivers the fluid from the reservoir in parallel to the one or more elements needing temperature control.

15. The system as recited in claim 11, wherein the feedback sensor (114) is located within a machine element needing to be temperature monitored.

16. The system as recited in claim 11, wherein the feedback sensor (114) is located within the piping system at or near a machine element needing to be temperature monitored

17. The system as recited in claim 1, wherein the feed back sensor (114) monitors a temperature of an outgoing fluid such that the outgoing fluid temperature is controlled with the heat generating device.

18. The system as recited in claim 1, further comprising the local controller (116) configured to activate the heat generating device in accordance with a triggering event.

19. The system as recited in claim 18, wherein the triggering event includes a change in operation of a machine element needing to be temperature monitored.

20. The system as recited in claim 1, wherein the heat generating device (110) includes a mixture of fluids (512) from a plurality of flows of different temperatures wherein at least one of the flows is regulated to provide a desired temperature.

21. A method for regulating temperatures locally for machine elements, comprising:
providing a reservoir (112) common to a plurality of flow paths through an apparatus, the reservoir having a fluid with a controlled temperature of a first value;
delivering the fluid (212) from the reservoir to elements needing temperature control; and
generating a thermal change (110) at a location at or near the elements having a need for temperature control by generating or removing heat at or near the elements by sensing a local temperature and controlling a heat generating/removal device in accordance with a set point temperature such that the heat generating/removal device controls the temperature of the elements locally to each element to accurately maintain the temperature relative to the first value and independently of the other elements.

22. The method as recited in claim 21, wherein the sensing (210) includes feed forward sensing to monitor a temperature of an incoming fluid to anticipate changes in heat loads.

23. The method as recited in claim 21, wherein the sensing (114) includes monitoring a temperature of an outgoing fluid such that the outgoing fluid temperature is controlled with the heat generating/removal device.

24. The system as recited in claim 21, further comprising a controller (116) configured to activate the heat generating/removal device (110) in accordance with a triggering event, the method including feed forward sensing (210) and feed back sensing (212) to respectively monitor incoming and outgoing fluid temperatures and adjust the fluid temperatures with the heat generating/removal device.

25. The method as recited in claim 21, wherein the triggering event includes a change in operation of a machine element needing to be temperature monitored.

26. The method as recited in claim 21, wherein generating includes mixing different temperature fluids (512) from a plurality of flows such that at least one of the flows is regulated to provide a desired temperature.
